(19) United States
(12) Patent Application Publication
(10) Pub. No.: US 2025/0278622 A1
(43) Pub. Date: Sep. 4, 2025

(54) ON-CHIP HYPERDIMENSIONAL COMPUTING USING MIXED-SIGNAL CIRCUITS

(71) Applicant: ARIZONA BOARD OF REGENTS ON BEHALF OF ARIZONA STATE UNIVERSITY, Scottsdale, AZ (US)

(72) Inventor: Arindam Sanyal, Scottsdale, AZ (US)

(73) Assignee: ARIZONA BOARD OF REGENTS ON BEHALF OF ARIZONA STATE UNIVERSITY, Scottsdale, AZ (US)

(21) Appl. No.: 19/062,650

(22) Filed: Feb. 25, 2025

Related U.S. Application Data
(60) Provisional application No. 63/559,550, filed on Feb. 29, 2024.

(51) Int. Cl. G06N 3/065; G06F 7/58

(52) U.S. Cl. CPC G06N 3/065; G06F 7/582

(57) ABSTRACT

An on-chip hyperdimensional computing device (HDC) for classifying objects, where the HDC that incorporates shallow neural networks as part of the encoder in the HDC. The HDC maps input entities into random vectors of very high dimensionality (>10 k dimensions), performs simple operations (superposition, additive/multiplicative binding, permutation) on these hyperdimensional vectors (HVs), and computes their similarity to existing HVs to perform the object classification.

### CROSS REFERENCE TO RELATED APPLICATIONS

This application claims the benefit of U.S. Provisional Patent Application No. 63/559,550, entitled On-Chip Hyperdimensional Computing Using Mixed-Signal Circuits, filed on Feb. 29, 2024, the contents of which are hereby incorporated by reference in its entirety.

### TECHNICAL FIELD

The present disclosure relates to a chip design for object classification.

### BACKGROUND

Artificial intelligence/machine learning (AI/ML) chips have been developed for various applications, such as, for example, but not limited to, for a static-random access memory (SRAM) macro for vector matrix multiplication with variable resolution input and output activations at normalized energy efficiency of 908TOPS/W, for an on-chip reservoir computer for stress detection from ECG signal, and for a three-layer artificial neural network chip for atrial fibrillation detection from ECG signal. The AI chips are designed using compute-in-memory mixed-signal circuits to achieve <20 nJ energy/classification and have ˜10-50× higher energy efficiency than their digital counterparts while having similar accuracy. The AI circuits use a software-hardware co-design methodology that uses transfer curves from transistor models to train the AI models to ensure analog nonlinearities are accounted for during model training.

What is needed is a reservoir-computer product to generate and encode orthogonal hyperdimensional vectors (HVs) which have higher dimensions than the input symbols. What is further needed is the incorporation of brain-inspired features into the reservoir, such as, for example, but not limited to, lateral inhibition, that makes neurons sensitive to spatially varying stimulus and is important for visual perception, and dynamic leak that improves robustness, eliminates high frequency noise and provides better generalization to the AI model. What is still further needed is to employ fully dynamic circuits. The fully dynamic circuit provides zero static power and reduces energy consumption. What is even still further needed is an SRAM array with embedded capacitor to improve the linearity of multiply-and-accumulate (MAC) operations in the neural network after the reservoir. Hyperdimensional computing (HDC) systems are suitable for implementation on a wide variety of hardware platforms, such as emerging neuromorphic hardware. Applications of HDC systems typically focus on optimizing memories, whereas what is needed is a combination hardware-software co-design technique, reservoir properties and dynamic analog circuit design to reduce memory and energy consumption.

### SUMMARY

A system and method in accordance with embodiments of the present disclosure provide an on-chip HDC. The on-chip HDC incorporates shallow neural networks as part of the encoder in the HDC. The HDC maps input entities into random vectors of very high dimensionality (>10 k dimensions), performs simple operations (superposition, additive/multiplicative binding, permutation) on these hyperdimensional vectors (HVs), and computes their similarity to existing HVs for classification. The on-chip HDC system improves memory access/usage, energy efficiency, and performance/accuracy. Primitive computing operations are provided to improve deployment on edge devices. Specifically, the on-chip HDC uses mixed-signal circuit design, HV generation and encoding happens in the analog domain, and intermediate results are stored as charge in the circuit nodes.

Datasets that can be used with a system and method in accordance with embodiments of the present disclosure include, but are not limited to including, medical diagnosis such as, for example, but not limited to, Physionet and Cardio, gesture recognition, activity recognition from motion sensors, image classification, speech recognition, and NASA turbofan. A system and method in accordance with embodiments of the present disclosure bring intelligence to edge devices and address the problem of sensor data deluge. Embedding AI modules inside edge devices allows intelligent filtering of data for selective transmission and can compress data to address data deluge. Reducing transmission data volume relaxes bandwidth bottlenecks in a communication network, and extends the battery life of edge devices. Thus, the on-chip mixed-signal HDC in accordance with embodiments of the present disclosure enable a variety of Internet of Things applications, from predictive maintenance of equipment and vehicles to autonomous target acquisition to patient health monitoring.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for determining a classification of an object from a set of classifications. The method includes determining prototype hyperdimensional vectors associated with the set of classifications based on prototype data, storing the prototype hyperdimensional vectors in an associative memory, determining query hyperdimensional vectors based on query data, including the object, comparing the query hyperdimensional vectors to the prototype hyperdimensional vectors, and determining the classification of the object based on the comparison. Other embodiments of this aspect include corresponding computer systems, apparatus, and computer programs recorded on one or more computer storage devices, each configured to perform the actions of the methods.

Implementations may include one or more of the following features. The method may include processing the query data including generating a seed vector, determining a factor based on the prototype data and the seed vector, determining the query hyperdimensional vectors based on the factor, and increasing a separation between the prototype hyperdimensional vectors and the query hyperdimensional vectors based at least on changes over time of the prototype hyperdimensional vectors and the query hyperdimensional vectors. The factor may include multiplying the prototype data by the seed vector. The seed vector may include a randomly-generated vector and/or orthogonality with other of the seed vectors, and/or a randomly-generated vector produced by a pseudo-random number generator, where the pseudo-random number generator may include a linear-feedback shift register. The linear-feedback shift register may include a device that produces 2^{M}−1 pseudo-random bits using m digital D-flip flops and the seed vector from a quantized input symbol. The seed vector may include a randomly-generated vector produced by a random number generator, where the random number generator may include a SRAM array. The random number generator may include a device that produces a random bitstream in which power-on states of bitcells are queried based on a quantized input symbol. The SRAM array may include a physical unclonable function (PUF) in which a random mismatch in the bitcells acts as an entropy source, where the quantized input symbol is a challenge bitstream and the power-on state of the queried bitcells is a response bitstream. Implementations of the described techniques may include hardware, a method or process, or computer software on a computer-accessible medium.

One general aspect includes a computer system for determining a classification of an object from a set of classifications. The computer system includes a hardware processor, and a non-volatile storage medium storing instructions that when executed by the hardware processor perform operations that may include determining prototype hyperdimensional vectors associated with the set of classifications based on prototype data, storing the prototype hyperdimensional vectors in an associative memory, determining query hyperdimensional vectors based on query data, including the object; comparing the query hyperdimensional vectors to the prototype hyperdimensional vectors; and determining the classification of the object based on the comparison. Other embodiments of this aspect include corresponding computer systems, apparatus, and computer programs recorded on one or more computer storage devices, each configured to perform the actions of the methods.

Implementations may include one or more of the following features. The operations further may include processing the query data including generating a seed vector, determining a factor based on the prototype data and the seed vector, determining the query hyperdimensional vectors based on the factor, and increasing a separation between the prototype hyperdimensional vectors and the query hyperdimensional vectors based at least on changes over time of the prototype hyperdimensional vectors and the query hyperdimensional vectors. The factor may include multiplying the prototype data by the seed vector. The seed vector may include a randomly-generated vector and/or orthogonality with other of the seed vectors, and/or a randomly-generated vector produced by a random number generator, where the random number generator may include a linear-feedback shift register. The linear-feedback shift register may include a device that produces 2^{M}−1 pseudo-random bits using m digital D-flip flops and the seed vector from a quantized input symbol. The seed vector may include a randomly-generated vector produced by a random number generator, where the random number generator may include a SRAM array, and where the random number generator includes a device that produces a random bitstream in which power-on states of bitcells are queried based on a quantized input symbol, and where the SRAM array includes a physical unclonable function (PUF) in which a random mismatch in bitcells acts as an entropy source, where the quantized input symbol is a challenge bitstream and a power-on state of the queried bitcells is a response bitstream. Implementations of the described techniques may include hardware, a method or process, or computer software on a computer-accessible medium.

One general aspect includes a computer program product for determining a classification of an object from a set of classifications. The computer program product includes a computer readable storage medium having program instructions embodied therewith. The program instructions are executable by a computing device to cause the computing device to perform operations including determining prototype hyperdimensional vectors associated with the set of classifications based on prototype data, storing the prototype hyperdimensional vectors in an associative memory, determining query hyperdimensional vectors based on query data, including the object. The operations also include comparing the query hyperdimensional vectors to the prototype hyperdimensional vectors, and determining the classification of the object based on the comparison. Other embodiments of this aspect include corresponding computer systems, apparatus, and computer programs recorded on one or more computer storage devices, each configured to perform the actions of the methods.

Implementations may include one or more of the following features. The computer program product where the operations further may include processing the query data including generating a seed vector, determining a factor based on the prototype data and the seed vector, determining the query hyperdimensional vectors based on the factor, and increasing a separation between the prototype hyperdimensional vectors and the query hyperdimensional vectors based at least on changes over time of the prototype hyperdimensional vectors and the query hyperdimensional vectors.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a pictorial description of an on-chip HDC in accordance with embodiments of the present disclosure using mixed-signal reservoir computing;

FIG. 2 is a graphical representation energy/accuracy/dimensionality of conventional HDCs versus the HDCs in accordance with embodiments of the present disclosure;

FIG. 3A is a schematic diagram of a reservoir layer in accordance with embodiments of the present disclosure;

FIG. 3B is a schematic diagram of a slice of the input layer in accordance with embodiments of the present disclosure;

FIG. 3C is a schematic diagram of a reservoir neuron in accordance with embodiments of the present disclosure;

FIG. 4 is a schematic diagram of a single-slice SRAM (9T1C) in-memory computing circuit for vector matrix multiplications;

FIG. 5 is a flowchart of a method in accordance with embodiments of the present disclosure; and

FIG. 6 is a layout view of a mixed-signal DC chip in accordance with embodiments of the present disclosure.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

A system and method in accordance with embodiments of the present disclosure is an on-chip hyper-dimensional computer (HDC) that incorporates shallow neural networks as part of the encoder in HDC. The HDC in accordance with embodiments of the present disclosure maps input entities into random vectors of very high dimensionality (>10 k dimensions), performs simple operations (superposition, additive/multiplicative binding, permutation) on these hyperdimensional vectors (HVs) and computes their similarity to prototype HVs for classification. A reservoir-computing (RC) paradigm is used for the on-chip implementation of the HDC. In the RC paradigm, random projections of the input data are performed, which is analogous to mapping the base symbols to random HVs in an embodiment in accordance with the present disclosure. Also in the RC paradigm, the reservoir states are updated by a random connection matrix, which is analogous to binding/permutations in the HDC of the present disclosure. The nonlinearity in the RC paradigm is similar to thresholding operations in the HDC of the present disclosure.

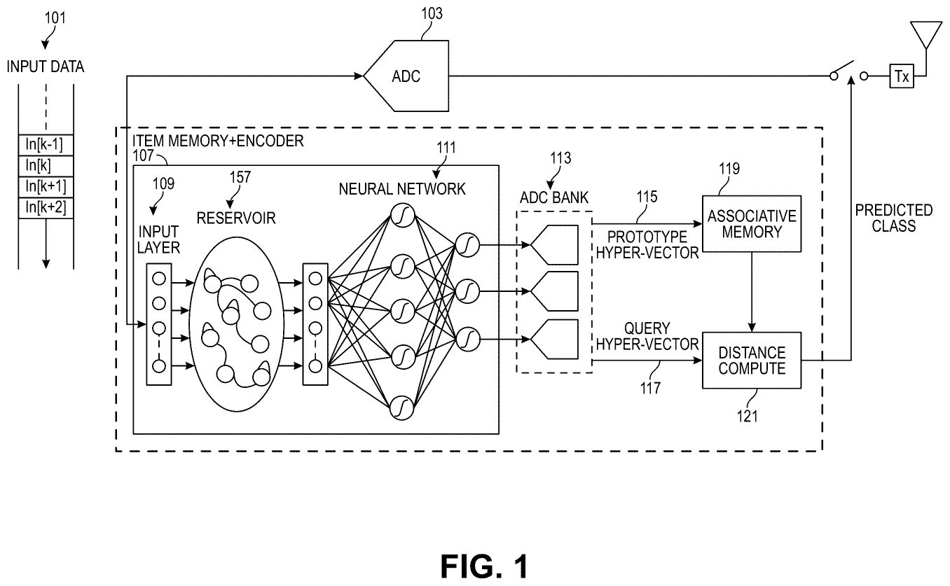

Referring now to FIG. 1, a system in accordance with embodiments of the present disclosure can include, but is not limited to including, item memory and encoder 107, ADC bank 113, prototype hypervector 115, query hypervector 117, associative memory 119, and distance computations 121. Item memory and encoder 107 can include an input layer 109, a reservoir layer 157, and a neural network 111. The input layer 109 maps the input symbols 101 (In[k]) to orthogonal HVs through multiplication with static random seed vectors that are generated on-the-fly based on nonlinear quantization of the input. The reservoir layer 157 performs permutations on the HVs through recurrent interconnections, and outputs of the reservoir neurons are passed through a shallow nonlinear neural network 111 to increase separation/distance between the HVs corresponding to different symbols. The neural network outputs are subsequently digitized by one or more ADCs 113, and stored as prototype HVs 115 in associative memory 119 for comparison against query HVs 117 during inference by a distance computation 121 to produce a predicted class that is converted to digital by ADC 103. In some configurations, the HDC circuits import transistor-level simulation results into the software AI model training for joint optimization of energy and memory consumption. In embodiments in accordance with the present disclosure, HV generation and encoding happen in the analog domain, and intermediate results are stored as charge in the circuit nodes without requiring additional storage and communication with separate memory which reduces power and area consumption significantly compared to conventional digital implementation. The recurrent connections inside the reservoir layer 157 impart properties of infinite-impulse response filters to the reservoir neurons which make their state-space infinite dimensional even though the dynamics of the reservoir 157 remains finite dimensional. Thus, the reservoir 157 exhibits high dimensionality relative to the number of physical neurons. The use of HDC leverages otherwise undesired random, static mismatches introduced during fabrication and analog nonlinearities to generate HVs with large separation, thus simultaneously improving HDC performance for learning and classification, as well as reducing circuit area and power consumption. Reducing transmission volume in a sensor by in-sensor analysis and compression of data is shown as follows: the sensor data are compressed after passing through the reservoir 157 and neural network 111 (output layer of the reservoir). The compression ratio is the sensor data volume/number of neurons in the neural network 111. For example, if the reservoir accepts 200 sensor data points that go through the reservoir 157, and the neural network has ten neurons so the end product is ten values, the compression ratio is 200/10=20.

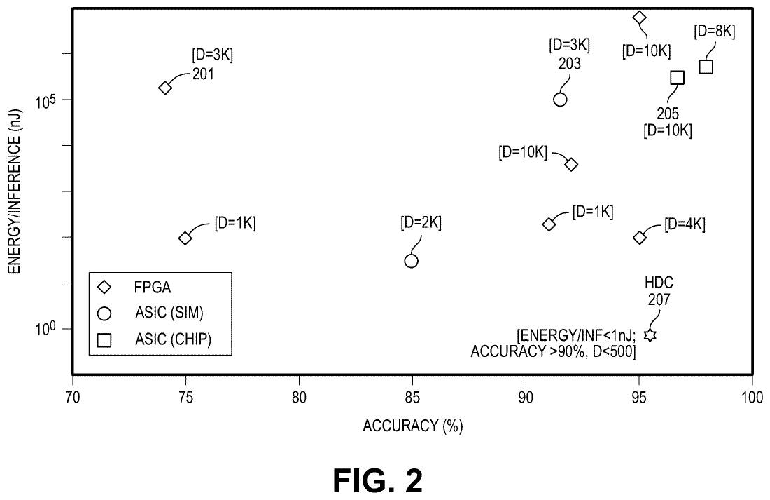

Referring now to FIG. 2, shown are energy/inference, accuracy, and dimensionality of the HV for a conventional HDC implemented on a FPGA 201, a simulated custom ASIC 203, and a test chip ASIC 205, compared to an embodiment of the HDC 207 of the present disclosure. As shown, the conventional HDCs 201/203/205 consume 80 nJ˜1 mJ/inference. The HDC 207 in accordance with embodiments of the present disclosure reduces the dimensionality of the HVs by >2×, the area by >10×, and energy consumption by >100× over conventional HDC hardware.

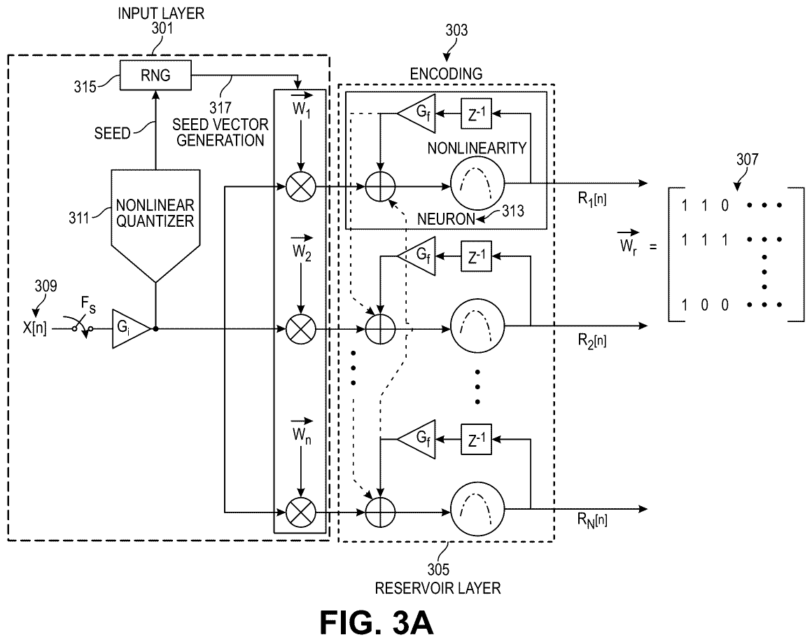

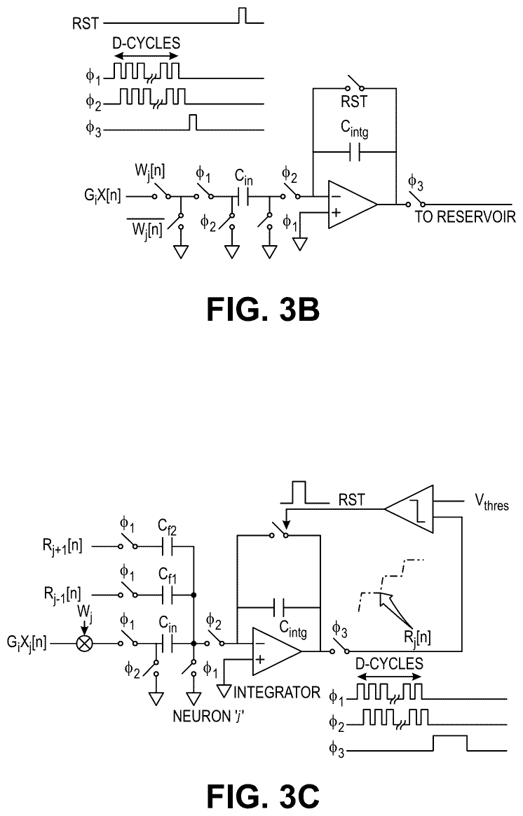

Referring now to FIG. 3A, an RC circuit is a computational framework for platforms with limited resources. The circuit includes an input layer 301 and encoding 303. The input layer 301 can include random number generator (RNG) 315 (or pseudo random number generator), nonlinear flash quantizer 311, and seed vector generation 317. In some configurations, switched-capacitor circuits are used in the reservoir layer 305 in which transfer functions are defined by ratios of capacitors and are robust against changes in operating conditions. Shown in FIG. 3A are the reservoir neurons 313 (details of which are shown in FIG. 3C) connected in a ring with a corresponding reservoir connectivity matrix 307. The input symbol 309, X[n], is quantized by a nonlinear flash quantizer 311 that generates the seed vector for a RNG 315 that produces the initial seed HVs 317. In some configurations, the RNG 315 is a linear-feedback shift register (LFSR) that produces 2^{M}−1 pseudo-random bits using M digital D-flip flops and seed from the quantized input symbol 309. In another configuration, the RNG 315 is a SRAM array in which the power-on states of the individual bitcells are queried based on the quantized input symbol 309, and an RNG bitstream is produced. The SRAM array acts a physical unclonable function (PUF) in which a random mismatch in the bitcells acts as an entropy source, the quantized input symbol 309 is the challenge bitstream and the power-on state of the queried bitcells is the response bitstream. A programmable inter-connection weight matrix is used to reconfigure the reservoir for different applications.

Referring now to FIGS. 3B and 3C, a low-gain, single-stage dynamic amplifier is used in the leaky integrator circuit and biased with current such that it operates in a non-linear slewing mode. The inter-connection weight matrix, and input and feedback scaling factors are set by ratios of capacitors. The reservoir neurons 313 (FIG. 3A and details in FIG. 3C) are grouped in small clusters in which if one neuron reaches threshold voltage and is reset as shown in FIG. 3C, the other neurons in that cluster are also reset, thus introducing lateral inhibition as exhibited in brain neurons. The analog neuron 313 of the present disclosure, shown in detail in FIG. 3C, is small relative to analog circuits that account for mismatch and nonlinearlity since nonlinearity due to component mismatch and slewing are absorbed into the nonlinear reservoir kernel and leveraged for classification. The reservoir neuron states pass through a shallow nonlinear neural network 111 (FIG. 1) for further separating the encoded HVs.

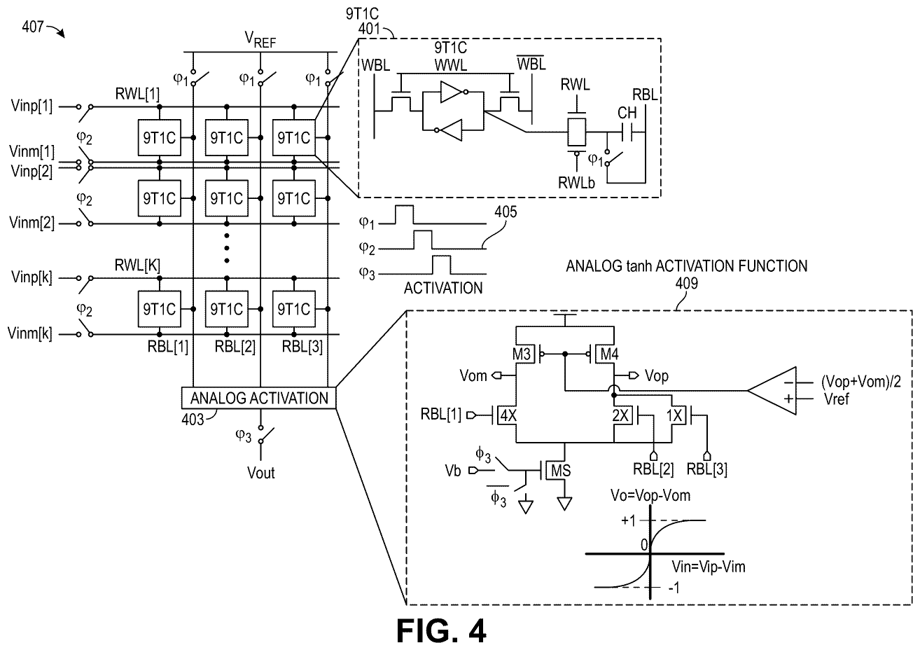

Referring now to FIG. 4, the mathematical operations in the neural network 111 (FIG. 1) are vector matrix multiplication (VMM) 407, which can be performed using in-memory computing (IMC), and nonlinear activation 403. An IMC circuit with 9 transistor+1 capacitor (9T1C) SRAM cell 401, and associated timing diagram 405 is illustrated for a single neuron with 3-bit weights. A complementary metal-oxide semiconductor (CMOS) switch is used to transmit the differential analog voltage and switched-capacitors to perform charge-mode accumulation with high linearity. The model weights are stored in 2's complement form (with most significant bit as the sign bit) for handling both positive and negative model weights. The in-memory matrix multiplications and activations are performed during the clock phases from ϕ₁ to ϕ₃. The read bit-line (RBL) is initially pre-charged to high voltage, and the neuron weight vector is stored in the SRAM array. The RBL is refreshed during ϕ₁. Input activations are applied differentially and simultaneously to the SRAM array through read word-lines (RWL/RWLb) during ¢2 and dot-product of input activations and neural network weights are available as voltage on RBL lines at the end of ϕ₂. In some configurations, for binary weighted summations of the RBL voltages, a combination of binary weighted compute capacitors and balance capacitors, that use charge sharing and redistribution to produce binary weighted outputs from the RBL voltages, are used. In some configurations, the binary weighted addition of RBL voltages is merged with the activation function circuits 403, as in FIG. 4, shown is a single slice of SRAM array 401 with 3-bit weights (with 1 sign bit) followed by tanh activation 409. The tanh activation function 409 uses a single-stage fully differential amplifier with RBL voltages applied to input transistors that are binary weighted and combine the different RBL voltages with proper binary weights in current domain. In some configurations, dynamic amplifiers are used to develop low-power sigmoid, tanh and rectified linear unit (ReLU) activation functions, for example. In some configurations, correction circuits are accommodated for by using software AI models that are trained using circuit transfer functions.

Referring again to FIG. 1, the encoded HVs from the reservoir-computer 157 are in analog form and will be digitized using a bank of ADCs 113. The ADCs 113 are calibrated to suppress mismatch between them. In some configurations, the digitized prototype HVs 115 are stored in SRAM based content addressable memory (CAM) that allows an arbitrary range of the array to be searched using the query HVs 117. In some configurations, an 8T-NOR type CAM that allows for search is used.

In some configurations, transistor physics is used for training AI models that are used in the neural network 111. In some configurations, for vision data, an untrained, convolutional layer is added at the front-end to extract a reduced feature map from images which act as input symbols to the HDC. In some configurations, if the target dataset cannot be trained on the on-chip HDC, the HDC is trained in batches using, for example, but not limited to, FPGAs. Random mismatch that introduces chip-to-chip variations can be addressed by re-training chips on a small training subset and updating the mapping between HVs and output classes.

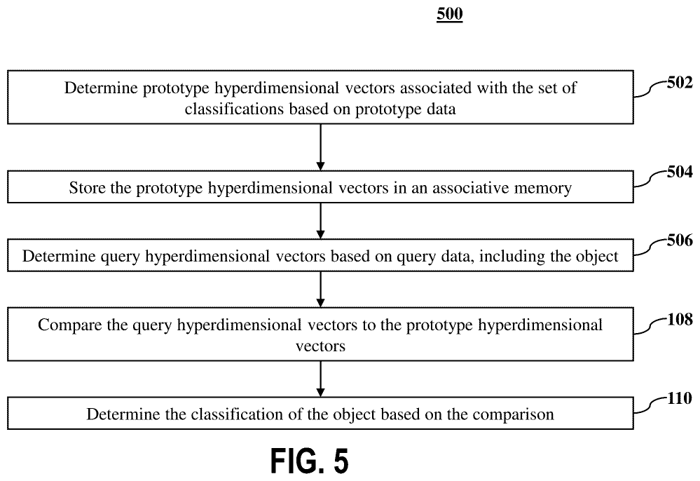

Referring now to FIG. 5, method 500 for determining a classification of an object from a set of classifications can include, but is not limited to including, determining 502 prototype hyperdimensional vectors associated with the set of classifications based on prototype data, storing 504 the prototype hyperdimensional vectors in an associative memory, determining 506 query hyperdimensional vectors based on query data, including the object, comparing 508 the query hyperdimensional vectors to the prototype hyperdimensional vectors, and determining 510 the classification of the object based on the comparison.

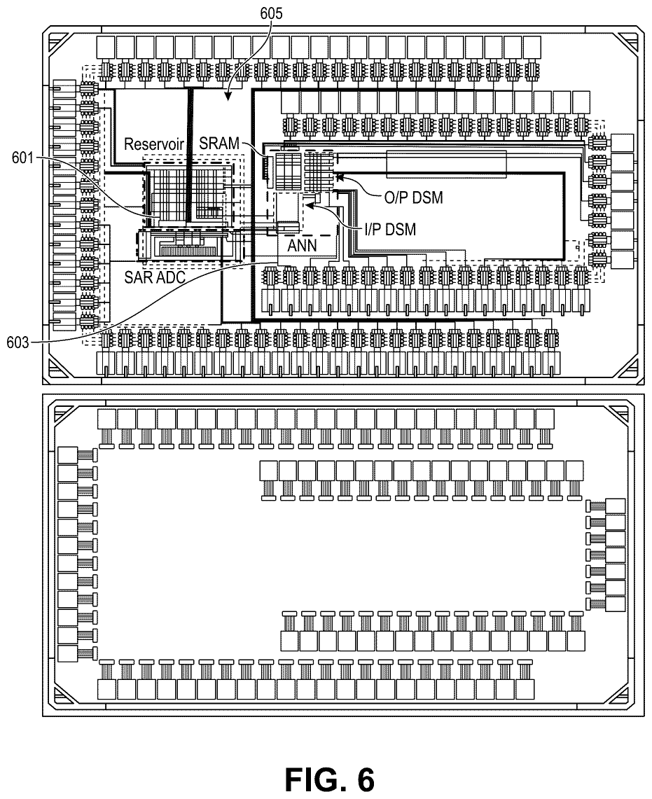

Referring now to FIG. 6, a chip, in accordance with embodiments of the present disclosure, is fabricated in 28 nm CMOS and occupies an area of 0.1 mm². The chip comprises of a 30-neuron reservoir layer for encoding and an ANN macro 603 for the output layer. The reservoir 601 consumes 7.2 μW at 31.25 kHz while the artificial neural network (ANN) macro 603 with 30×32-bit SRAM 605 consumes 12.3 μW at 312.5 kHz for an oversampling ratio (OSR) of 10. In some configurations, the SRAM 605 is delta-sigma-modulator (DSM)-based. Encoding and output layer operations are performed in batches and their results are combined off-chip. The reservoir outputs are digitized, serialized and pulled off-chip for training the output layer in each chip to reduce chip-to-chip variation.

Systems, methods, and computer program products are provided. In the detailed description herein, references to “various embodiments,” “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

1. A method for determining a classification of an object from a set of classifications, the method comprising:
determining prototype hyperdimensional vectors associated with the set of classifications based on prototype data;
storing the prototype hyperdimensional vectors in an associative memory;
determining query hyperdimensional vectors based on query data, including the object;
comparing the query hyperdimensional vectors to the prototype hyperdimensional vectors; and
determining the classification of the object based on the comparison.

2. The method of claim 1, further comprising:
processing the query data including:
generating a seed vector;
determining a factor based on the prototype data and the seed vector;
determining the query hyperdimensional vectors based on the factor; and
increasing a separation between the prototype hyperdimensional vectors and the query hyperdimensional vectors based at least on changes over time of the prototype hyperdimensional vectors and the query hyperdimensional vectors.

3. The method of claim 2, wherein the factor comprises:
multiplying the prototype data by the seed vector.

4. The method of claim 2, wherein the seed vector comprises:
a randomly-generated vector.

5. The method of claim 2, wherein the seed vector comprises:
orthogonality with other of the seed vectors.

6. The method of claim 2, wherein the seed vector comprises:
a randomly-generated vector produced by a pseudo-random number generator,
wherein the pseudo-random number generator comprises a linear-feedback shift register.

7. The method of claim 6, wherein the linear-feedback shift register comprises:
a device that produces 2^{M}−1 pseudo-random bits using M digital D-flip flops and the seed vector from a quantized input symbol.

8. The method of claim 2, wherein the seed vector comprises:
a randomly-generated vector produced by a random number generator,
wherein the random number generator comprises a SRAM array.

9. The method of claim 8, wherein the random number generator comprises:
a device that produces a random bitstream in which power-on states of bitcells are queried based on a quantized input symbol.

10. The method of claim 9, wherein the SRAM array comprises:
a physical unclonable function (PUF) in which a random mismatch in the bitcells acts as an entropy source,
wherein the quantized input symbol is a challenge bitstream and the power-on state of the queried bitcells is a response bitstream.

11. A computer system for determining a classification of an object from a set of classifications, the computer system comprising:
a hardware processor; and
a non-volatile storage medium storing instructions that when executed by the hardware processor perform operations comprising:
determining prototype hyperdimensional vectors associated with the set of classifications based on prototype data;
storing the prototype hyperdimensional vectors in an associative memory;
determining query hyperdimensional vectors based on query data, including the object;
comparing the query hyperdimensional vectors to the prototype hyperdimensional vectors; and
determining the classification of the object based on the comparison.

12. The computer system of claim 11, wherein the operations further comprise:
processing the query data including:
generating a seed vector;
determining a factor based on the prototype data and the seed vector;
determining the query hyperdimensional vectors based on the factor; and
increasing a separation between the prototype hyperdimensional vectors and the query hyperdimensional vectors based at least on changes over time of the prototype hyperdimensional vectors and the query hyperdimensional vectors.

13. The computer system of claim 12, wherein the factor comprises:
multiplying the prototype data by the seed vector.

14. The computer system of claim 12, wherein the seed vector comprises:
a randomly-generated vector.

15. The computer system of claim 12, wherein the seed vector comprises:
orthogonality with other of the seed vectors.

16. The computer system of claim 12, wherein the seed vector comprises:
a randomly-generated vector produced by a random number generator,
wherein the random number generator comprises a linear-feedback shift register.

17. The computer system of claim 16, wherein the linear-feedback shift register comprises:
a device that produces 2^{M}−1 pseudo-random bits using M digital D-flip flops and the seed vector from a quantized input symbol.

18. The computer system of claim 12, wherein the seed vector comprises:
a randomly-generated vector produced by a random number generator,
wherein the random number generator comprises a SRAM array, and
wherein the random number generator includes a device that produces a random bitstream in which power-on states of bitcells are queried based on a quantized input symbol, and
wherein the SRAM array includes:
a physical unclonable function (PUF) in which a random mismatch in bitcells acts as an entropy source,
wherein the quantized input symbol is a challenge bitstream and a power-on state of the queried bitcells is a response bitstream.

19. A computer program product for determining a classification of an object from a set of classifications, the computer program product comprising a computer readable storage medium having program instructions embodied therewith, the program instructions executable by a computing device to cause the computing device to perform operations comprising:
determining prototype hyperdimensional vectors associated with the set of classifications based on prototype data;
storing the prototype hyperdimensional vectors in an associative memory;
determining query hyperdimensional vectors based on query data, including the object;
comparing the query hyperdimensional vectors to the prototype hyperdimensional vectors; and
determining the classification of the object based on the comparison.

20. The computer program product of claim 19, wherein the operations further comprise:
processing the query data including:
generating a seed vector;
determining a factor based on the prototype data and the seed vector;
determining the query hyperdimensional vectors based on the factor; and
increasing a separation between the prototype hyperdimensional vectors and the query hyperdimensional vectors based at least on changes over time of the prototype hyperdimensional vectors and the query hyperdimensional vectors.
